(19) United States
(12) Patent Application Publication
(10) Pub. No.: US 2020/0249518 A1
(43) Pub. Date: Aug. 6, 2020

(54) DISPLAY APPARATUS

(71) Applicant: Mitsubishi Electric Corporation, Tokyo (JP)

(72) Inventor: Hiroshi TERAMOTO, Tokyo (JP)

(73) Assignee: Mitsubishi Electric Corporation, Tokyo (JP)

(21) Appl. No.: 16/752,531

(22) Filed: Jan. 24, 2020

(30) Foreign Application Priority Data
Jan. 31, 2019 (JP) 2019-015894

(51) Int. Cl. G02F 1/1333; F21V 8/00; G02F 1/1345

(52) U.S. Cl. CPC G02F 1/133308; G02B 6/0088; G02F 2001/133314; G02F 2001/13332; G02F 1/13452

(57) ABSTRACT

In a display apparatus of the present invention, an extension of a rear frame and an extension of a front frame are combined to oppose each other, so that structures (the extensions) having high stiffness are disposed on side surfaces of the display apparatus opposing each other. With an increase in stiffness of the display apparatus including the rear frame and the front frame, the display apparatus as a whole is less likely to be deformed by an external force.

### BACKGROUND OF THE INVENTION

### Field of the Invention

The present invention relates to a display apparatus including a backlight irradiating a display panel.

### Description of the Background Art

A typical display apparatus includes a display panel to display an image and a backlight to irradiate the display panel, and the display panel and the backlight are engaged with each other by a frame. A liquid crystal display apparatus includes, as the display panel, a liquid crystal display panel containing liquid crystals within a pair of substrates and including polarizing plates disposed on outer surfaces of the pair of substrates to sandwich the pair of substrates, and a backlight to irradiate the liquid crystal display panel. The liquid crystal display apparatus also includes a wiring member to connect the liquid crystal display panel and a circuit board to transmit an external video signal to the liquid crystal display panel.

These days, a display apparatus is incorporated in various apparatuses and products, and is widely used as an interface to operate the apparatuses and the products and to display information. With an increase in variety of uses of the apparatus, the display apparatus comes to be used in highly-loaded vibration and shock environments brought, for example, by an external force, and thus required to have high durability.

Japanese Utility Model Application Laid-Open No. 5-71823 discloses a display apparatus having a module structure including a frame having a frame body having a rectangular channel-shape cross section and a liquid crystal panel and a driving unit housed in the frame, and one side surface of the module is fixed by a fixing frame having a rectangular channel-shape cross section. A heat seal (a wiring member connecting the liquid crystal panel and the driving unit) is disposed to curve along an inner side of the fixing frame with one end portion thereof being inserted between a lower surface of an upper portion of the frame and an upper surface of the liquid crystal panel. According to a display apparatus disclosed in Japanese Patent Application Laid-Open No. 2009-86115, a frame holds three marginal portions of a liquid crystal panel to reinforce a substrate and a substrate.

In the display apparatus disclosed in Japanese Utility Model Application Laid-Open No. 5-71823, the display panel and the wiring member connecting the display panel and the driving unit are covered with three parts, that is, the frame, the fixing frame, and the driving unit. By an external force pressing the center of the display panel while left and right sides, upper and lower sides, or all four sides of the display apparatus are held, the display apparatus is deformed from part junctions of the frame, the fixing frame, and the driving unit, and the display panel housed inside and the wiring member connecting the display panel having low stiffness and the driving unit are bent, and can be damaged when the force exceeds a critical strength of the member.

In the display apparatus disclosed in Japanese Patent Application Laid-Open No. 2009-86115, one side is open for ease of assembly of the display apparatus. This causes a problem in that, by an external force pressing the center of a display panel while two or more sides in a peripheral portion are held, the open side of the display panel is bent simultaneously with deformation of the frame, and damage can be caused even if the external force is weak.

### SUMMARY

It is an object to provide a highly reliable display apparatus in which damage of a display panel and breaking of a wiring member are less likely to occur.

A display apparatus of the present invention includes a backlight including an optical member and a rear frame having a bottom surface and a first side surface contiguous with the bottom surface to enclose the optical member and; a display panel irradiated with light by the backlight to display an image; a circuit board to control the display panel; a wiring member to electrically connect the circuit board and the display panel; and a front frame having an opening in an upper surface and a second side surface contiguous with the upper surface to enclose the backlight and the display panel and hold the wiring member, wherein the rear frame has a first extension contiguous with the first side surface and bent inward in a direction parallel to the bottom surface, the front frame has a second extension contiguous with the second side surface and bent inward in a direction parallel to the upper surface, and the first extension of the rear frame and the second extension of the front frame are located to oppose each other.

According to the above-mentioned display apparatus, a highly reliable display apparatus in which damage of the display panel and breaking of the wiring member are less likely to occur can be achieved.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an exploded perspective view of a display apparatus according to the present invention;

FIG. 2 is a perspective view of a display panel of the present invention;

FIG. 3 is a sectional view of the display apparatus in FIG. 1 in an assembled state taken along the line A-A;

FIG. 4 is a perspective view of a rear frame of the display apparatus of the present invention;

FIG. 5 is a perspective view of a front frame of the display apparatus of the present invention;

FIG. 6 is a sectional view of the display apparatus of the present invention;

FIG. 7 is a conceptual diagram of fixing of the display apparatus of the present invention and an external force load;

FIG. 8 is a sectional view of a typical display apparatus;

FIGS. 9A and 9B show sectional views of rear frames and the second moments of area; and

FIG. 10 is a sectional view of a display apparatus in Embodiment 2 of the present invention.

### DESCRIPTION OF THE PREFERRED EMBODIMENTS

### Embodiment 1

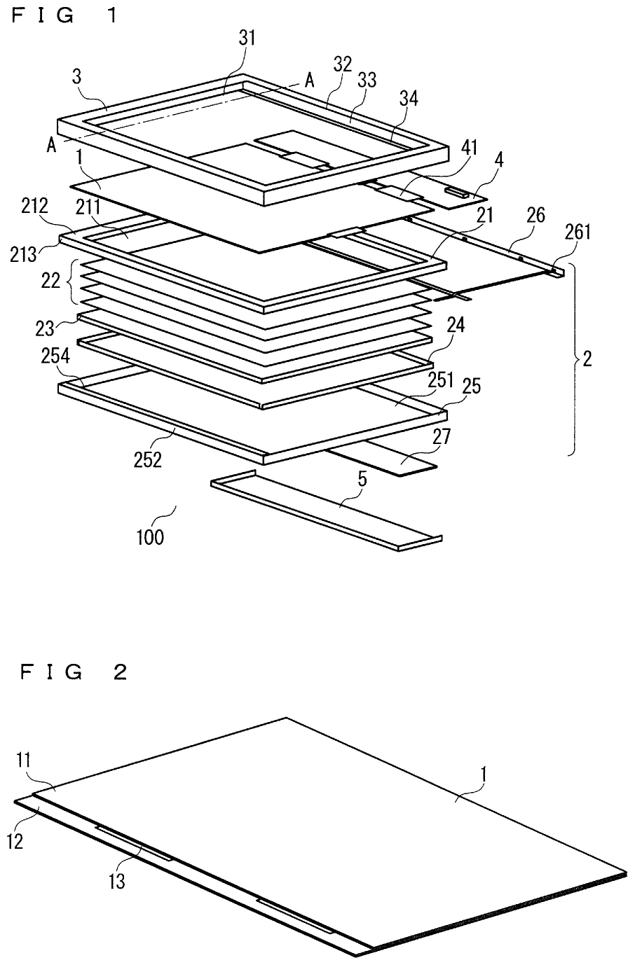

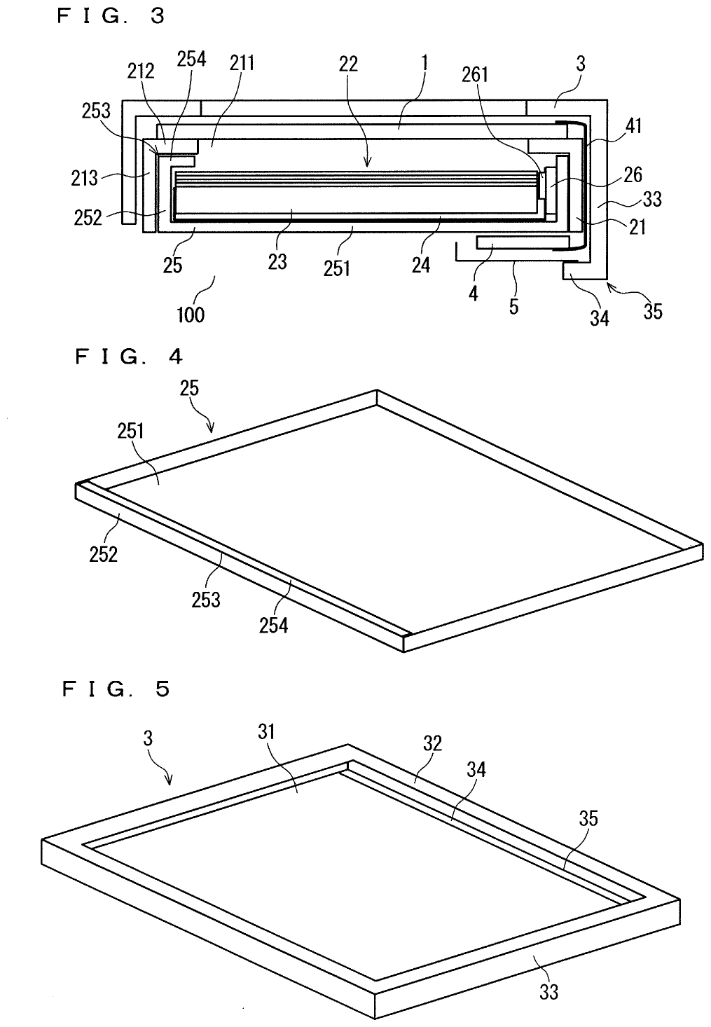

FIG. 1 is an exploded perspective view of a display apparatus of the present invention. FIG. 2 is a perspective view of a display panel of the display apparatus of the present invention. FIG. 3 is a sectional view of the display apparatus in FIG. 1 in an assembled state taken along the line A-A. FIG. 4 is a perspective view of a rear frame of the display apparatus of the present invention. FIG. 5 is a perspective view of a front frame of the display apparatus of the present invention. As illustrated in FIG. 1, a display apparatus 100 of the present invention includes a display panel 1, a backlight 2 irradiating the display panel 1 from behind, a front frame 3 enclosing the display panel 1 and the backlight 2 and having an opening 31, and a circuit board 4. The circuit board 4 is connected to the display panel 1 through flexible printed circuits (hereinafter, FPCs) 41 as wiring members. The display apparatus 100 includes a shielding cover 5 to protect the circuit board 4 on a rear side. A touch panel (not illustrated) to externally input a positional signal into a screen and a substantially transparent protective member (not illustrated) to protect the touch panel are disposed on a front surface of the display panel 1 in some cases.

<Display Panel>

As illustrated in FIG. 2, the display panel 1 is configured by a transmissive or partially transmissive liquid crystal display panel and the like, and displays an image through application of birefringence of liquid crystals. The display panel 1 includes: a first substrate 11 including an insulating substrate made, for example, of glass, and a color filter, a light shielding layer, a counter electrode, and the like formed on the insulating substrate; and a second substrate 12 including a thin film transistor (TFT) as a switching element, a pixel electrode, and the like. The display panel 1 also includes a spacer (not illustrated) to keep a distance between the first substrate 11 and the second substrate 12, a sealing member (not illustrated) to bond the first substrate 11 and the second substrate 12 together, liquid crystals (not illustrated) sandwiched between the substrates, an inlet sealing member (not illustrated) to seal an inlet for injecting the liquid crystals, an alignment film (not illustrated) to align the liquid crystals, polarizing plates (not illustrated) disposed on outer side surfaces of the substrates, a driving integrated circuit (IC) 13 disposed in a peripheral portion of the second substrate 12, and the like.

<Backlight>

As illustrated in FIG. 1 or 3, the backlight 2 includes a light source substrate 26 including light sources 261 to emit light, a light guiding plate 23 having an exit surface receiving light emitted from the light sources 261 from the side and propagating the light forward and an opposite exit surface opposing the exit surface, optical sheets 22 disposed on the exit surface of the light guiding plate 23 to control distribution and spread of light emitted from the light guiding plate 23, and a reflective plate 24. The backlight 2 also includes a rear frame 25 having a bottom surface 251 and side surfaces 252 to enclose these optical members and a middle frame 21 having an opening 211 in an upper surface 212 and side surfaces 213 disposed to oppose the side surfaces 252 of the rear frame to be engaged with the rear frame 25 to thereby hold the rear frame 25. The backlight 2 irradiates the display panel 1 from a side of the second substrate 12 (see FIG. 2) opposing a display surface of the display panel 1 with light emitted from the opening 211 of the middle frame 21.

<Light Sources>

As the light sources 261, point light sources (not illustrated), such as LEDs, or fluorescent tube lamps (not illustrated) of red, green, and blue (RGB) and a luminescent color other than RGB are arranged. When the point light sources are used, a typical glass epoxy resin-based substrate or a flexible flat cable may be used as the light source substrate 26 on which the light sources 261 are mounted. Alternatively, a metal-based substrate, such as an aluminum-based substrate, or a ceramic-base substrate may be used to increase heat dissipation. The light source substrate 26 is bonded to the light guiding plate 23, the rear frame 25, or the like to be held.

<Light Guiding Plate and Reflective Plate>

The light guiding plate 23 is formed of transparent acrylic resin, polycarbonate resin, glass, and the like. The exit surface and the opposite exit surface of the light guiding plate 23 have dot patterns for scattering or prism shapes to adjust intensity distribution and an exit direction of in-plane light while allowing light to exit. The light guiding plate 23 may be fixed to the rear frame 25 using a double-faced tape and the like. The reflective plate 24 is disposed on the opposite exit surface, side surfaces, and the like of the light guiding plate 23 to direct light escaping from the light guiding plate 23 to the light guiding plate 23 again.

<Optical Sheets>

The optical sheets 22 are arranged on the exit surface of the light guiding plate 23 to adjust intensity distribution and an exit angle of an exit light. As the optical sheets 22, the required number of sheets including a lens sheet to collect light, a diffusing sheet to homogenize light, a viewing angle adjusting sheet to adjust luminance in a direction of a viewing angle, and the like are arranged depending on an intended use. A resin material, such as polycarbonate (PC) and polyethylene terephthalate (PET), is used as a material for the optical sheets 22.

<Circuit Board>

The circuit board 4 controls the display panel 1 and the light sources using an electrical input/output signal, and is typically formed of glass epoxy and the like having a copper pattern. Electronic parts are mounted on the surface of the circuit board 4 using solder, and the circuit board 4 is disposed and fixed on a side of a rear surface (a side on which light does not exit) of the display apparatus 100. In the display apparatus 100 of the present invention, the circuit board 4 is disposed at the rear of the bottom surface 251 of the rear frame 25.

<FPCs>

The FPCs 41 are flexible wiring members each including a film base and wiring formed on the film base, and are used to connect the circuit board 4 and the display panel 1. Each of the FPCs 41 has one end portion connected to a wiring unit formed in a peripheral portion of the display panel 1 and the other end portion connected to a connection portion of the circuit board 4. A signal from the circuit board 4 is thereby input into the display panel 1. The FPCs 41 are arranged on one of the side surfaces 213 of the middle frame 21.

<Shielding Cover>

The shielding cover 5 is a protective member formed of metal, such as aluminum, stainless steel, and galvanized sheet steel, or a thin film resin, such as PET, to protect the circuit board 4 from external pressure and static electricity. In the present embodiment, the shielding cover 5 made of metal is used to protect the parts mounted on the circuit board 4, and is disposed at the bottom of the display apparatus 100 at the rear of the rear frame 25 and is fixed by being inserted into the front frame 3 or being fastened to the rear frame 25 using a screw.

<Insulating Sheet>

When the shielding cover 5 is used, it is desirable to bond an insulating sheet 27 formed of a sheet resin, such as PET, to interrupt electrical connection between the shielding cover 5 and the electronic parts mounted on the circuit board 4 for insulation. The insulating sheet 27 has an adhesive on one surface thereof to be fixed to the shielding cover 5. To fix the circuit board 4, an adhesive tape is boned onto the insulating sheet 27 or a threaded hole for fixing a screw is formed in the insulating sheet 27 in some cases.

<Rear Frame>

As illustrated in FIG. 1, 3, or 4, the rear frame 25 is box-shaped to enclose the optical members, and has peripheral portions vertically standing on the bottom surface 251 to form side walls. That is to say, the rear frame 25 has the bottom surface 251 and the side surfaces 252 vertically formed to be contiguous with the sides of the bottom surface 251. The rear frame 25 is engaged with the middle frame 21 by a hook formed on the side surfaces 252 of the rear frame 25 and a catch and the like formed on the side surfaces 213 of the middle frame 21 to correspond to the hook, or is fixed to the middle frame 21 using a screw. With this configuration, the rear frame 25 holds the optical members, the display panel 1, and the like while keeping a clearance of 0.1 to several millimeters.

The light source substrate 26 including the light sources 261 is disposed on one of the side surfaces 252 of the rear frame 25. It is desirable that the rear frame 25 be formed using metal having high thermal conductivity to conduct heat emitted from the light sources 261. By using an aluminum or aluminum alloy housing having particularly high thermal conductivity, heat from the light sources 261 is efficiently dissipated so that buildup of heat in the backlight 2 can be prevented.

<Middle Frame>

As illustrated in FIGS. 1 and 3, the middle frame 21 has the opening 211 to allow light from the exit surface of the light guiding plate 23 to exit, the upper surface 212 in which the opening 211 is formed, and the side surfaces 213 vertically formed to be contiguous with the upper surface 212. The display panel 1 is loaded, positioned, and held to oppose the upper surface 212. As a material for the middle frame 21, metal, such as aluminum, stainless steel, and iron, and a resin material, such as PC and acrylonitrile butadiene styrene (ABS), can be used.

<Front Frame>

As illustrated in FIG. 1, 3, or 5, the front frame 3 is a frame-like member to hold the display panel 1 and the backlight 2, and is configured by a metal thin plate, a resin molded product, or the like. The front frame 3 has an upper surface 32 in which the opening 31 is formed to cover, from the front, a peripheral portion, such as cut end portions of the first substrate 11 formed, for example, of glass and a mounted terminal portion (an end portion of the first substrate 11 in which the driving IC 13 is disposed) of the display panel 1, and the FPCs 41 connected to the mounted terminal portion, and has side surfaces 33 vertically bent from respective sides of the upper surface 32 at an outline end of the display apparatus 100 and the opening 31 coinciding with a display region of the display panel 1. An installation structure is disposed on the bent side surfaces 33 to fit with a hook-like fixing structure or a thread fastening structure formed on the backlight 2 to integrate the display apparatus 100. At the same time, a threaded hole, an installation hole, and the like (not illustrated) may be provided in a structure protruding from side surfaces, a front surface, or a peripheral portion to install the display apparatus 100 in an end product.

As illustrated in FIG. 1, 3, or 4, the rear frame 25 of the display apparatus 100 of the present invention has an extension 254 contiguous with, from among the vertically formed side surfaces 252, a side surface 252 having a side opposing a side on which the circuit board 4 is disposed, horizontally bent inward at a bend 253 to be parallel to the bottom surface 251, and extending so that the side surface 252 has a rectangular channel-shape cross section. Although an example in which the extension 254 of the rear frame 25 is formed on one of the side surfaces 252 opposing another one of the side surfaces 252 contiguous with a portion of the bottom surface 251 on which the circuit board 4 is disposed is described, the extension 254 may be formed on the other one of the side surfaces 252 contiguous with (adjacent to) the portion of the bottom surface 251 on which the circuit board 4 is disposed. It is desirable that opposite ends of the extension 254 horizontally bent from the bend 253 be located close to side surfaces other than the side surface on which the extension 254 is formed without being connected to the other side surfaces. It is desirable that the extension 254 have a length of 2 mm or more while it will be described below.

As illustrated in FIG. 1, 3, or 5, as with the rear frame 25, the front frame 3 of the display apparatus 100 of the present invention has an extension 34 contiguous with, from among the side surfaces 33 vertically formed with respect to the upper surface 32, a side surface 33 having a side opposing a side on which the extension 254 of the rear frame 25 is formed, horizontally bent inward at a bend 35 to be parallel to the upper surface 32, and extending so that the side surface 33 has a rectangular channel-shape or c-shape cross section.

As illustrated in FIG. 3, in a case where the rear frame 25 is engaged as a part included in the backlight 2, the side surfaces 252 of the rear frame 25 is covered with the middle frame 21 to be integrated with the middle frame 21. A structure fitting with the front frame 3 is disposed on the side surfaces 252 of the rear frame 25 or the side surfaces 213 of the middle frame 21 so that the extension 254 of the rear frame 25 and the extension 34 of the front frame 3 are combined to oppose each other.

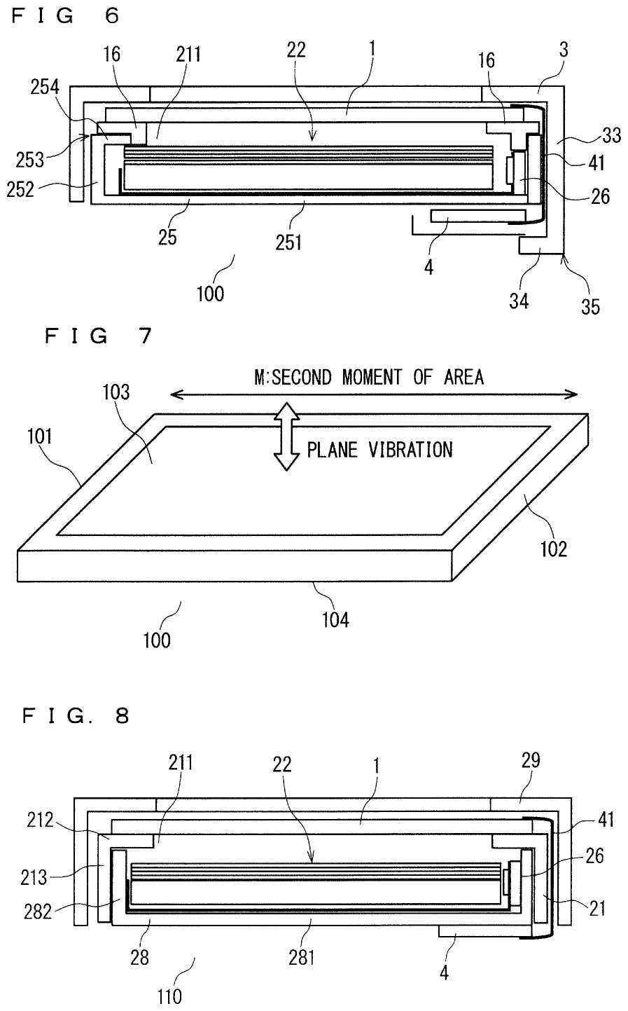

As illustrated in a sectional view of the display apparatus in FIG. 6, the rear frame 25 having the extension 254 bent inward from one of the side surfaces 252 of the rear frame 25 may be incorporated as a part external to the backlight 2. The extension 254 of the rear frame 25 is included inward, and fit with the middle frame 16 for integration. Furthermore, a structure fitting with the side surfaces 33 of the front frame 3 is disposed on the side surfaces 252 of the rear frame 25 so that the extension 254 of the rear frame 25 and the extension 34 of the front frame 3 are combined to oppose each other.

<Action>

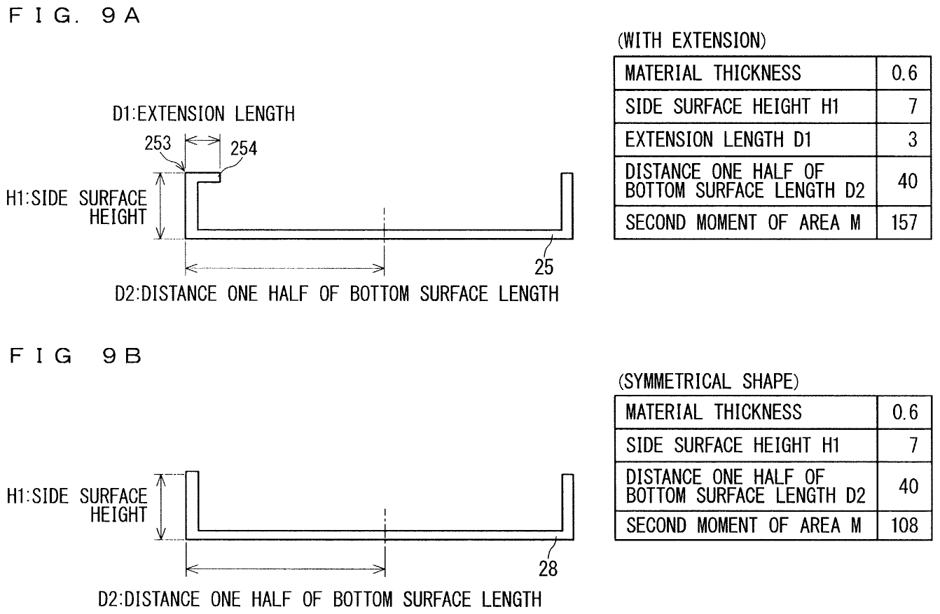

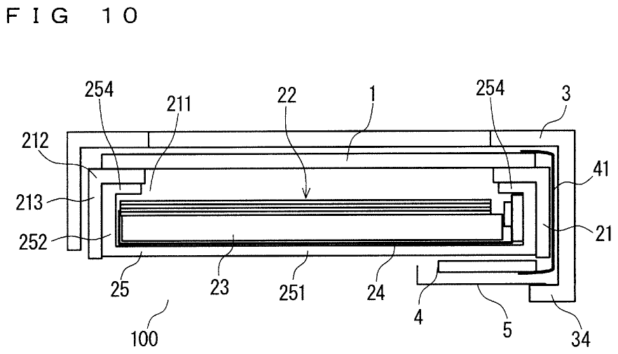

FIG. 7 is a conceptual diagram for explaining fixing of the display apparatus 100 of the present invention and an external force load. FIG. 8 is a sectional view of a typical display apparatus. FIGS. 9A and 9B show sectional views of rear frames and the second moments of area. As illustrated in FIG. 7, in a case where the display apparatus 100 of the present invention is vibrated in a direction of an upper surface 103 and a lower surface 104 while a side surface 101 and a side surface 102 opposite the side surface 101 are fixed to a housing and the like (not illustrated) (in a case of plane vibration), the second moment of area in a direction of the side surface 101 affects deformation caused by an external force.

FIG. 8 is the sectional view of the typical display apparatus. As illustrated in FIG. 8, in a typical display apparatus 110, each of a rear frame 28 and a front frame 29 has no extension. FIG. 9B shows a calculated value of the second moment of area M of the rear frame 28 of the display apparatus 110. In a case where the thickness of a material for the rear frame 28, that is, a plane thickness, is 0.6 mm, the height H1 of each of side surfaces 282 of the rear frame 28 is 7 mm, and a distance D2 that is one half of the length of a bottom surface 281 is 40 mm in cross section, the second moment of area M is 108 mm⁴. In contrast, in a case where the material thickness is 0.6 mm, the height H1 of each of the side surfaces 252 is 7 mm, the distance D2 of the length of the bottom surface 251 is 40 mm, and the length D1 of the extension 254 is 3 mm in cross section of the rear frame 25 having the extension 254 of the present invention shown in FIG. 9A, the second moment of area M is 157 mm⁴ when the bend 253 of one of the side surfaces 252 on the other side remains as a standing wall, so that an approximately 1.5-fold increase in bending stiffness can be achieved. While the extension 254 of the rear frame 25 of the present invention has a length of 3 mm, the extension 254 can be bent, and desired stiffness can be obtained when the extension 254 has a length of 2 mm or more.

<Effects>

As described above, in the display apparatus 100 of the present invention, the extension 254 of the rear frame 25 and the extension 34 of the front frame 3 are combined to oppose each other as illustrated in FIG. 1 or 3, so that structures (the extensions 254 and 34) having high stiffness are disposed on the side surfaces 101 and 102 of the display apparatus 100 opposing each other in FIG. 6. With an increase in stiffness of the display apparatus 100 including the rear frame 25 and the front frame 3, the display apparatus 100 as a whole is less likely to be deformed by an external force. Deformation and stress acting on the display panel 1 included inside the display apparatus 100 and having low stiffness and the FPCs 41 connected to the display panel 1 can be reduced to prevent damage of the display panel 1 and breaking of the FPCs 41, so that the display apparatus 100 having high reliability can be achieved.

Furthermore, deformation and stress acting on the display panel 1 and the FPCs 41 connected to the display panel 1 can be reduced to prevent separation of the FPCs 41 from the display panel 1 to thereby prevent interruption of the electrical input/output signal supplied to the display panel 1, so that the display apparatus 100 having high reliability can be achieved.

<Modifications>

Assembly is improved by separately providing the extension 254 of the rear frame 25 and the extension 34 of the front frame 3 respectively to one of the side surfaces 252 and one of the side surfaces 33.

Furthermore, the extension is applicable to the middle frame 21. In a case where the middle frame 21 has the bend (not illustrated), stiffness of the backlight 2 can be improved. In this case, the middle frame 21 may be formed of metal, and have an extension bent from one of the side surfaces 213.

Similar effects can be obtained when the middle frame 21 having the extension in place of the front frame 3 is combined with the rear frame 25. In this case, the front frame 3 is not necessarily required to have the extension 34. The extension 34, however, can further improve stiffness, and yield the display apparatus 100 having higher reliability.

### Embodiment 2

FIG. 10 is a sectional view of a display apparatus in Embodiment 2 of the present invention. In the display apparatus in Embodiment 1, the extension 254 of the rear frame 25 bent inward and the extension 34 of the front frame 3 bent inward are combined to oppose each other. In Embodiment 2, the box-shaped rear frame 25 has extensions 254 on two of the side surfaces 252 opposing each other as illustrated in FIG. 10. Although a configuration in which the extension 34 of the front frame 3 bent inward is formed on one of the side surfaces is illustrated as in Embodiment 1, extensions 34 may be formed on two side surfaces of the front frame 3 opposing each other as with the rear frame 25 in Embodiment 2.

Consideration is made with reference to FIGS. 9A and 9B. In a case where the material thickness is 0.6 mm, the side surface height H1 is 7 mm, the distance that is one half of the bottom surface length D2 is 40 mm, the extension length D1 is 3 mm, and the other end has the same shape, the second moment of area M is 206 mm⁴, so that an approximately twofold increase in bending stiffness can be achieved compared with the typical display apparatus (FIG. 8). Stiffness of the display apparatus 100 including the rear frame 25 and the front frame 3 can be improved compared with that in Embodiment 1.

Embodiments of the present invention can freely be combined with each other, and can be modified or omitted as appropriate within the scope of the invention.

While the invention has been shown and described in detail, the foregoing description is in all aspects illustrative and not restrictive. It is therefore understood that numerous modifications and variations can be devised without departing from the scope of the invention.

What is claimed is:

1. A display apparatus comprising:
a backlight including an optical member and a rear frame having a bottom surface and a first side surface contiguous with the bottom surface to enclose the optical member and;
a display panel irradiated with light by the backlight to display an image;
a circuit board to control the display panel;
a wiring member to electrically connect the circuit board and the display panel; and
a front frame having an opening in an upper surface and a second side surface contiguous with the upper surface to enclose the backlight and the display panel and hold the wiring member, wherein
the rear frame has a first extension contiguous with the first side surface and bent inward in a direction parallel to the bottom surface,
the front frame has a second extension contiguous with the second side surface and bent inward in a direction parallel to the upper surface, and
the first extension of the rear frame and the second extension of the front frame are located to oppose each other.

2. A display apparatus comprising:
a backlight including an optical member and a rear frame having a bottom surface and a first side surface contiguous with the bottom surface to enclose the optical member and;
a display panel irradiated with light by the backlight to display an image;
a circuit board to control the display panel;
a wiring member to electrically connect the circuit board and the display panel; and
a middle frame having an opening in an upper surface and a third side surface contiguous with the upper surface to hold the backlight, wherein
the rear frame has a first extension contiguous with the first side surface and bent inward in a direction parallel to the bottom surface,
the middle frame has a third extension contiguous with the third side surface and bent inward in a direction parallel to the upper surface, and
the first extension of the rear frame and the third extension of the middle frame are located to oppose each other.

3. The display apparatus according to claim 1, wherein
the circuit board is located outwardly from the bottom surface of the rear frame on a side of a side surface opposite the first side surface of the rear frame contiguous with the first extension.

4. The display apparatus according to claim 2, wherein
the circuit board is located outwardly from the bottom surface of the rear frame on a side of a side surface opposite the first side surface of the rear frame contiguous with the first extension.

5. The display apparatus according to claim 1, wherein
the rear frame further has a fourth extension bent inward from a side surface opposite the first side surface of the rear frame contiguous with the first extension in the direction parallel to the bottom surface.

6. The display apparatus according to claim 2, wherein
the rear frame further has a fourth extension bent inward from a side surface opposite the first side surface of the rear frame contiguous with the first extension in the direction parallel to the bottom surface.

7. The display apparatus according to claim 1, wherein
the first extension of the rear frame has a length of 2 mm or more.

8. The display apparatus according to claim 2, wherein
the first extension of the rear frame has a length of 2 mm or more.

9. The display apparatus according to claim 1, wherein
the second extension of the front frame is located to oppose the circuit board.

10. The display apparatus according to claim 2, wherein
the first extension of the rear frame is not connected to the third side surface of the middle frame adjacent to the first side surface contiguous with the first extension.
